(19) United States
(12) Patent Application Publication
(10) Pub. No.: US 2025/0165126 A1
(43) Pub. Date: May 22, 2025

(54) INFORMATION PROCESSING SYSTEM, NON-TRANSITORY COMPUTER READABLE MEDIUM AND INFORMATION PROCESSING METHOD

(71) Applicant: FUJIFILM Business Innovation Corp., Yokohama-shi (JP)

(72) Inventors: Yuki YAMANAKA, Kanagawa (JP); Masahiro YAMADA, Kanagawa (JP)

(73) Assignee: FUJIFILM Business Innovation Corp., Yokohama-shi (JP)

(21) Appl. No.: 18/663,569

(22) Filed: May 14, 2024

(30) Foreign Application Priority Data
Nov. 20, 2023 (JP) 2023-196889

(51) Int. Cl. G06F 3/0484; G06F 3/0481; G06F 3/0488; H04N 1/00

(52) U.S. Cl. CPC G06F 3/0484; G06F 3/0481; G06F 3/0488; H04N 1/00411; H04N 1/00477; H04N 2201/0094

(57) ABSTRACT

An information processing system includes at least one processor configured to, after accepting an instruction to delete an information item displayed in a superimposed manner on a part of a display screen of a display unit and deleting the information item, redisplay the information item by an operation of a specific user on a screen currently displayed on the display unit.

### CROSS-REFERENCE TO RELATED APPLICATIONS

This application is based on and claims priority under 35 USC 119 from Japanese Patent Application No. 2023-196889 filed Nov. 20, 2023.

### BACKGROUND

### (i) Technical Field

The present disclosure relates to an information processing system, a non-transitory computer readable medium and an information processing method.

### i(ii) Related Art

Japanese Unexamined Patent Application Publication No. 2015-132888 discloses a display control device including a display control means that causes a display unit to display a second display item superimposed on a first display item, a selection means that selects a display item displayed on the display unit, and a control means that performs control so as not to accept a selection operation of the second display item within a predetermined time from the start of display of the second display item.

### SUMMARY

Aspects of non-limiting embodiments of the present disclosure relate to providing an information processing system and an information processing method that allow a user to check the content of an information item on a screen currently displayed on a display unit after the information item displayed in a superimposed manner on a part of a display screen is deleted by a deletion operation of the user, and a non-transitory computer readable medium used therewith.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including at least one processor that, after accepting an instruction to delete an information item displayed in a superimposed manner on a part of a display screen of a display unit and deleting the information item, redisplays the information item by an operation of a specific user on a screen currently displayed on the display unit.

### BRIEF DESCRIPTION OF THE DRAWINGS

Exemplary embodiments of the present disclosure will be described in detail based on the following figures, wherein:

FIG. 1 is a block diagram illustrating a hardware configuration of an information processing system according to a first exemplary embodiment;

FIG. 2 is a block diagram illustrating an example of a functional configuration of the information processing system;

FIG. 3 is a diagram illustrating an operation screen for an operation of executing transmission processing, which is displayed on an operation panel of the information processing system;

FIG. 4 is a diagram illustrating an example of a display screen of a banner and a delete button displayed on the operation panel of the information processing system;

FIG. 5 is a diagram illustrating an example of a display screen after a banner displayed on the operation panel of the information processing system is deleted;

FIG. 6 is a diagram illustrating another example of a display screen after a banner displayed on the operation panel of the information processing system is deleted;

FIG. 7 is a diagram illustrating an example of a display screen of an operation mark for redisplay displayed on the operation panel of the information processing system;

FIG. 8 is a diagram illustrating an example of a display screen on which a banner displayed on the operation panel of the information processing system is redisplayed;

FIG. 9 is a diagram illustrating an example of a display screen of another operation mark for redisplay which is displayed on the operation panel of the information processing system;

FIG. 10 is a flowchart illustrating a flow of processing of the information processing system according to a first exemplary embodiment;

FIG. 11A is a diagram illustrating a display screen on which a status display banner is displayed on the operation panel of the information processing system according to a first modification; FIG. 11B is a diagram illustrating a display screen on which a notification banner is displayed; and FIG. 11C is a diagram illustrating a display screen on which an error banner is displayed;

FIG. 12 is an explanatory diagram of relations between a plurality of operation marks and banners to be redisplayed on the operation panel of the information processing system according to the first modification;

FIG. 13A is a diagram illustrating an example of an operation for deleting a banner on the operation panel of the information processing system according to a second modification; and FIG. 13B is a diagram illustrating an example of an operation for redisplaying a banner;

FIG. 14 is a block diagram illustrating a hardware configuration of an information processing system according to a second exemplary embodiment;

FIG. 15 is a diagram illustrating a home screen in a user terminal according to the second exemplary embodiment;

FIG. 16 is a diagram illustrating an example of a display screen of a plurality of banners in the user terminal according to the second exemplary embodiment;

FIG. 17 is a diagram illustrating a display screen on which a plurality of operation marks is displayed in the user terminal according to the second exemplary embodiment;

FIG. 18A is a diagram illustrating a screen for operating a first operation mark in the user terminal according to the second exemplary embodiment; and FIG. 18B is a diagram illustrating a state in which the notification content of a deleted first banner is redisplayed;

FIG. 19A is a diagram illustrating a screen for operating a second operation mark in the user terminal according to the second exemplary embodiment; and FIG. 19B is a diagram illustrating a state in which the notification content of a deleted second banner is redisplayed; and

FIG. 20A is a diagram illustrating a screen for operating an operation mark in a user terminal according to a third modification; FIG. 20B is a diagram illustrating a state of operating an operation mark on a screen indicating notification content of a redisplayed banner; and FIG. 20C is a diagram illustrating a screen on which a plurality of banners is redisplayed.

### DETAILED DESCRIPTION

Hereinafter, an example of an exemplary embodiment of the present disclosure will be described with reference to the drawings. Note that in the drawings, the same or equivalent components and parts are denoted by the same reference signs. In addition, dimensional ratios in the drawings are exaggerated for convenience of description and may be different from the actual ratios.

### First Exemplary Embodiment

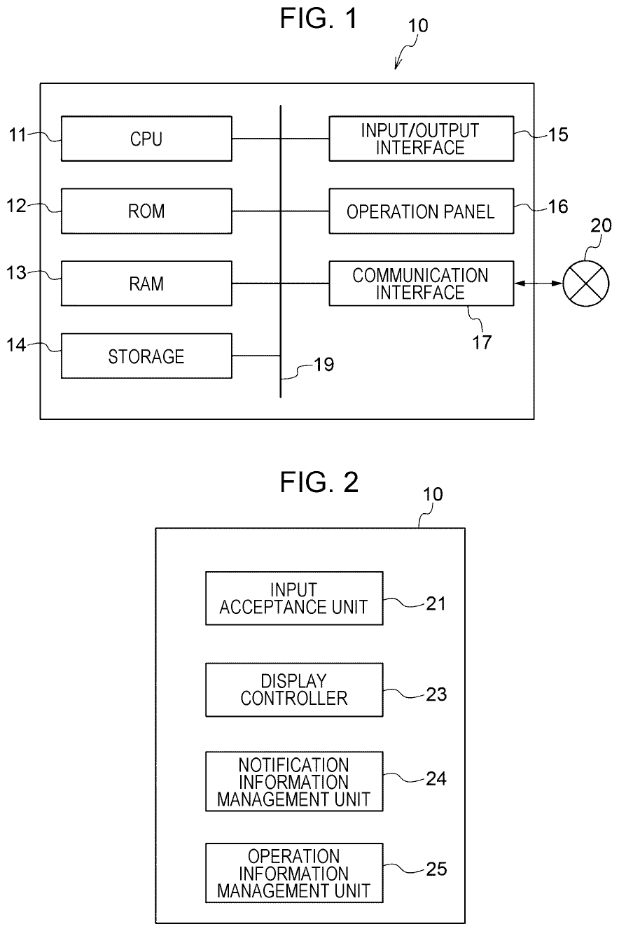

FIG. 1 is a block diagram illustrating a hardware configuration of an information processing system 10 according to a first exemplary embodiment.

### (Hardware Configuration of Information Processing System)

In one example, the information processing system 10 includes, for example, a multifunction peripheral having functions such as copying, printing, facsimile (FAX), e-mail sending/reception, and scanning. Alternatively, the information processing system 10 may be applied to a computer apparatus such as a desktop computer, a notebook computer, or a tablet computer having an e-mail sending function. A “system” in the present disclosure includes both a system configured by a plurality of devices and a system configured by a single device.

As illustrated in FIG. 1, the information processing system 10 includes each component such as a central processing unit (CPU) 11, a read only memory (ROM) 12, a random access memory (RAM) 13, a storage 14, an input/output interface 15, an operation panel 16, and a communication interface 17. The components are communicably connected to each other via a bus 19.

The CPU 11 is a central processing unit, and executes various programs and controls each unit. The CPU 11 is an example of a processor. The CPU 11 reads a program from the ROM 12 or the storage 14, and executes the program using the RAM 13 as a work area. The CPU 11 controls the above-described components and performs various kinds of arithmetic processing in accordance with programs recorded in the ROM 12 or the storage 14. According to the present exemplary embodiment, the ROM 12 or the storage 14 stores an information processing program.

The ROM 12 stores therein various kinds of programs or various types of data. The RAM 13, as a work area, temporarily stores therein programs or data. The storage 14 includes a hard disk drive (HDD) or a solid state drive (SSD) and stores various programs including an operating system, and various types of data.

The input/output interface 15 is an interface to transmit and receive information to and from a peripheral device. Although not illustrated, examples of the peripheral device include a printer that outputs an image onto a recording medium, a scanner that reads image information of an original, and a facsimile that transmits and receives data. For example, the CPU 11 may transmit image data to a printer via the input/output interface 15, and thus the printer may output the image data to a recording media.

The operation panel 16 is, for example, a liquid crystal display, and is an example of a display unit that displays various types of information. In one example, the operation panel 16 is a touch panel user interface (UI). The touch panel UI is a user interface that may be operated by touching a display with a finger or the like as a pointing device. The touch panel UI enables direct operations by pointing at an operation target such as an icon or a button displayed on the screen. The operation panel 16 has a function of displaying various kinds of information and a function of accepting an operation by a user. According to the first exemplary embodiment, the operation panel 16 is a touch panel display in which a touch panel is superimposed on a liquid crystal display. That is, the operation panel 16 functions as an input unit to perform various inputs and various instructions.

The communication interface 17 is an interface to communicate with a network 20, and for example, a standard such as Ethernet (registered trademark), FDDI, or Wi-Fi (registered trademark) is used. The network 20 is, for example, the Internet, or a wired or wireless network. The information processing system 10 is connected to a server (not illustrated) via the network 20, and may communicate information with the server.

### (Functional Configuration of Information Processing System)

FIG. 2 is a block diagram illustrating an example of a functional configuration of the information processing system 10.

As illustrated in FIG. 2, the information processing system 10 includes, as a functional configuration, an input acceptance unit 21, a display controller 23, a notification information management unit 24, and an operation information management unit 25. Each functional configuration is implemented by the CPU 11 reading an information processing program stored in the ROM 12 or the storage 14 and loading and executing the information processing program in the RAM 13.

The input acceptance unit 21 accepts an input from a user as an example of an operator. The input acceptance unit 21 accepts, for example, an input by a user's touch or gesture operation on the operation panel 16.

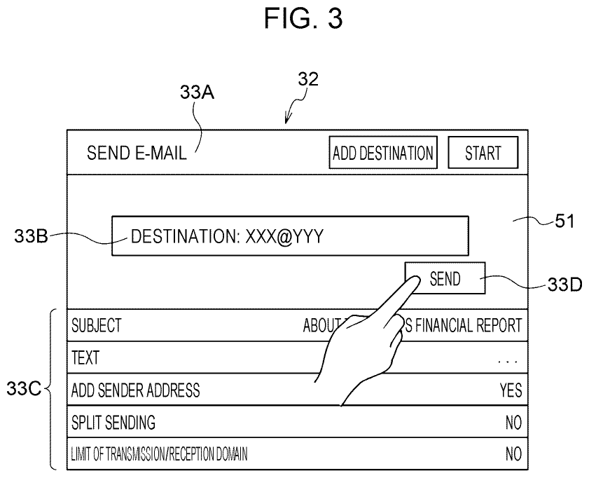

The input acceptance unit 21 accepts, for example, a user's instruction to execute a job. Examples of the job include sending of an e-mail, printing of image information on a recording medium, copying of an original onto a recording medium, scanning for reading information of an original, and facsimile communication of data. For example, when the input acceptance unit 21 has accepted an instruction to transmit an e-mail from the user, the e-mail is transmitted to the specified destination (see FIG. 3).

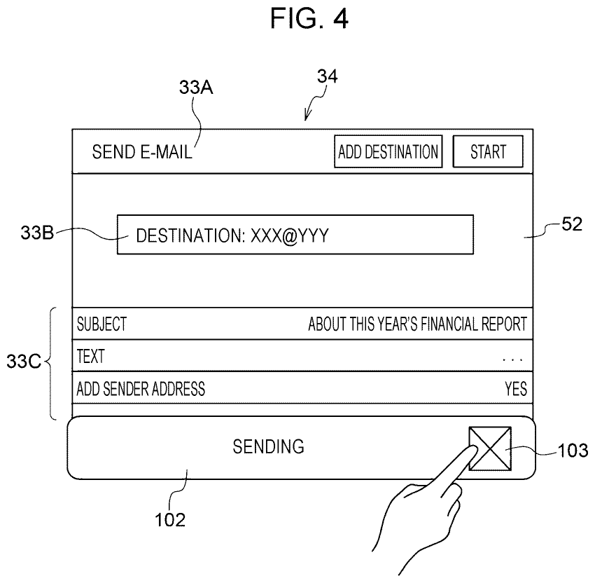

The input acceptance unit 21 accepts, for example, an instruction to delete a banner 102 from the user (see FIG. 4). The banner 102 is a word that means a flag or a streamer, and is an example of an information item in which information for notifying (i.e., informing) the user is described. The acceptance of the user's instruction to delete the banner 102 will be described below.

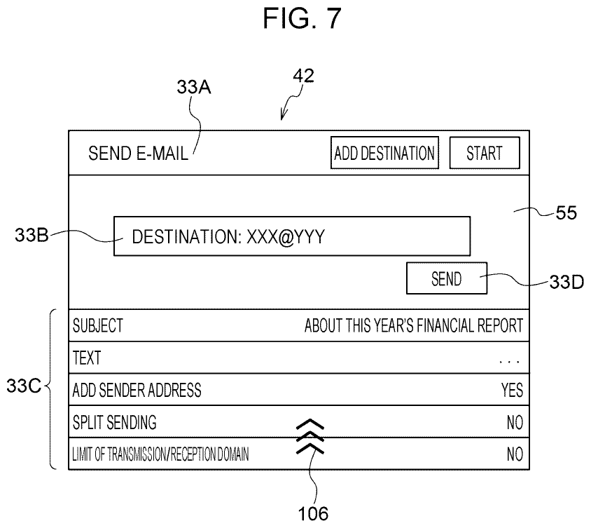

Furthermore, for example, the input acceptance unit 21 accepts, on the currently displayed screen, an instruction to redisplay the deleted banner 102 in response to an operation of the specific user (see FIG. 7). The acceptance of the user's instruction to redisplay the deleted banner will be described below.

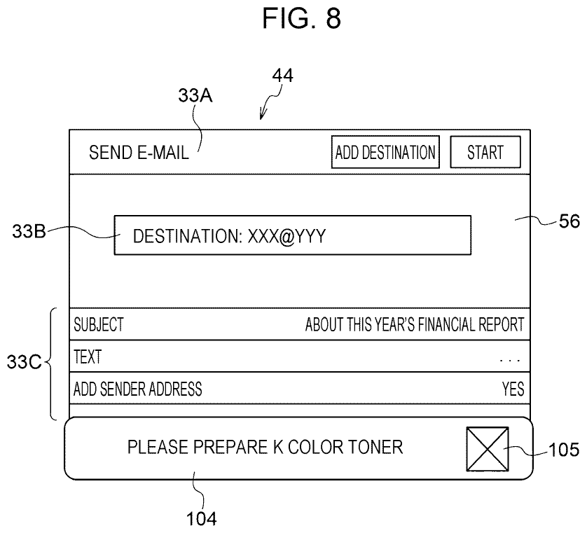

The display controller 23 controls a screen to be displayed on the operation panel 16. According to the first exemplary embodiment, the display controller 23 controls, on the display screen of the operation panel 16, display of a banner, or the like, describing the information to be notified to the user. The display controller 23 controls the screen to be displayed on the operation panel 16 so that, for example, the operation panel 16 displays a banner display screen 34 (see FIG. 4) in which the banner 102 is displayed on a part of the display screen in a superimposed manner, an instruction screen 42 (see FIG. 7) in which an operation mark 106 for redisplaying a deleted banner 104 (see FIG. 8) on the currently displayed screen, and the like. The various screens to be displayed on the operation panel 16 will be described below.

The notification information management unit 24 manages information to be notified to the user. The notification information management unit 24 and the operation information management unit 25 include a table (not illustrated) for managing, for example, the type of banner relating to notification information, an operation corresponding to deletion of a banner, the presence or absence of explicit deletion of a banner by a user, information on a deleted banner, and the like. The notification information management unit 24 manages information to be notified to the user by a table. The information to be notified to the user is displayed as the banner 102 in a superimposed manner on a part of a display screen 52 (see FIG. 4).

The notification information management unit 24 may acquire the information to be notified to the user from the network 20 via the communication interface 17, for example.

The operation information management unit 25 manages information of an operation by the user. The operation information management unit 25 manages, for example, operation information such as user's touch, swipe, and gesture operation on the display screen. Here, the touch refers to a touch action with a user's finger, and the swipe refers to an action of placing a user's finger on the screen and sliding it in an arbitrary direction.

The operation information management unit 25 manages the operation information to delete the banner, the operation information of the operation mark 106 (see FIG. 7) corresponding to the deletion of the banner, and the like, by the above table. In one example, the operation information management unit 25 manages an operation method for the operation mark 106 and an instruction to redisplay the banner in association with each other.

### (Example of Display Screen)

Here, an example of a display screen to be displayed on the operation panel 16 will be described.

As illustrated in FIG. 3, when e-mail sending as an example of a job is executed, an execution screen 32 is displayed on the operation panel 16 (see FIG. 1). On the execution screen 32, a job display 33A indicating that the job is e-mail sending, a destination 33B to which the e-mail is sent, an item field 33C indicating a plurality of items such as a subject, a send button 33D for executing sending of the e-mail, and the like, are displayed on a display screen 51. When the user presses (i.e., clicks) the send button 33D, the CPU 11 (see FIG. 1) accepts the user's instruction to execute e-mail sending. Thus, e-mail sending is executed.

When e-mail sending is executed, as illustrated in FIG. 4, the operation panel 16 displays a banner display screen 34 in which the banner 102 is displayed in a superimposed manner on a part (for example, the item field 33C) of the display screen 52. The display screen 52 is an example of a display screen of the operation panel 16. As an example, in the banner 102, the information to be notified to the user (e.g., the information that an e-mail is being sent) is described in a rectangular frame displayed in a superimposed manner on a part of the display screen 52. As an example, a delete button 103 for deleting the banner 102 is displayed at one end portion of the banner 102 in the longitudinal direction. When the user presses (i.e., clicks) the delete button 103, the CPU 11 accepts an instruction to delete the banner 102. That is, an operation of the delete button 103 is an explicit instruction to delete the banner 102 from the user. Instead of pressing the delete button 103, the banner 102 may be deleted by swiping the banner 102 in a specified direction.

The CPU 11 may delete the banner 102 after displaying the banner 102 in a part of the display screen 52 for a specified time. In this case, the CPU 11 deletes the banner 102 without accepting an explicit instruction to delete the banner 102 from the user.

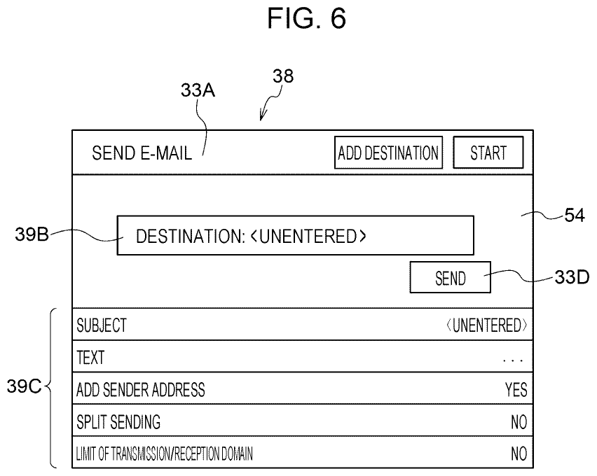

When the instruction to delete the banner 102 is accepted, as illustrated in FIG. 6, for example, the operation panel 16 displays an input screen 38 for executing sending of a new e-mail. In the input screen 38, the job display 33A for e-mail sending, a destination input portion 39B in which a new destination may be input, an item field 39C for inputting a plurality of items such as a subject, the send button 33D, and the like, are displayed in a displayed screen 54.

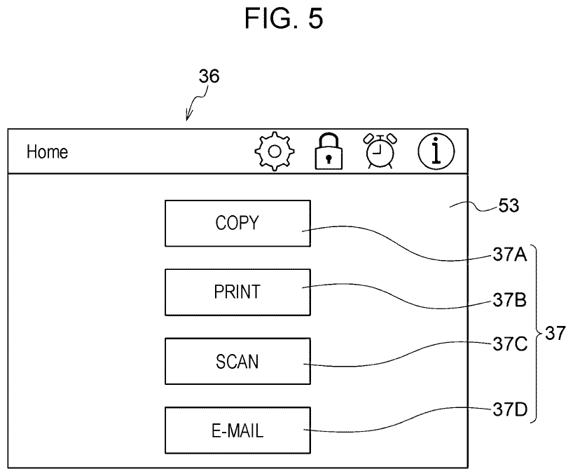

When the instruction to delete the banner 102 is accepted, the operation panel 16 may display a home screen 36 illustrated in FIG. 5 instead of the input screen 38 illustrated in FIG. 6. On the home screen 36, a plurality of job contents 37 such as a copy 37A for copying an original to a recording medium, a print 37B for printing image information on a recording medium, a scan 37C for reading original information, and an e-mail 37D for sending a document to a designated address by communication are displayed on a displayed screen 53.

When the banner is deleted by an explicit banner deletion instruction from the user, as illustrated in FIG. 7, an instruction screen 42 is displayed, which displays the operation mark 106 for redisplaying the banner on the currently displayed screen 55. The screen 55 is an example of a screen currently displayed on the operation panel 16. FIG. 7 illustrates an example in which the banner 104 (see FIG. 8) was deleted. As an example, on the instruction screen 42, the operation mark 106 is displayed on a part of the screen 55 where the job display 33A of e-mail sending, the destination 33B to which the e-mail is sent, the item field 33C, the send button 33D, and the like, are displayed. By displaying the operation mark 106 on a part of the currently displayed screen 55, it is possible to know that there is the banner 104 that was deleted and may be redisplayed. In one example, the operation mark 106 is displayed at a position that is on the lower side of the currently displayed screen 55 and that is overlapped with the item field 33C (e.g., a position close to the position where the deleted banner 104 was displayed).

The operation mark 106 is, for example, a mark in which three semi-transparent triangles are arranged in the vertical direction on the currently displayed screen 55 so that the apexes of the triangle face upward. For example, an instruction to redisplay the deleted banner 104 (see FIG. 8) is accepted when the specific user presses the operation mark 106. In one example, the specific user is the user who deleted the banner 104. Further, the operation of the specific user for redisplaying the banner 104 is an operation by one action on the currently displayed screen 55 (for example, pressing of the operation mark 106). Further, instead of pressing the operation mark 106, an instruction to redisplay the deleted banner 104 may be accepted by swiping the operation mark 106 in the upward direction, which is the direction of the apexes of the three triangles.

When an instruction to redisplay the deleted banner 104 (see FIG. 8) is accepted, as illustrated in FIG. 8, a banner display screen 44 is displayed, in which the banner 104 is redisplayed on a part of a currently displayed screen 56. The screen 56 is an example of a screen currently displayed on the operation panel 16. On the banner display screen 44, the banner 104 is redisplayed at the position where the deleted banner 104 was originally displayed on the currently displayed screen 56. At one end portion of the banner 104 in the longitudinal direction, a delete button 105 for deleting the banner 104 is displayed.

Although not illustrated, in a case where the banner 102 illustrated in FIG. 4 is deleted by the delete button 103, the banner 102 is redisplayed in the lower portion of the currently displayed screen by operating the operation mark displayed on the screen currently displayed on the operation panel 16. The banner display screen on which the banner 102 is redisplayed is the same as that in FIG. 4.

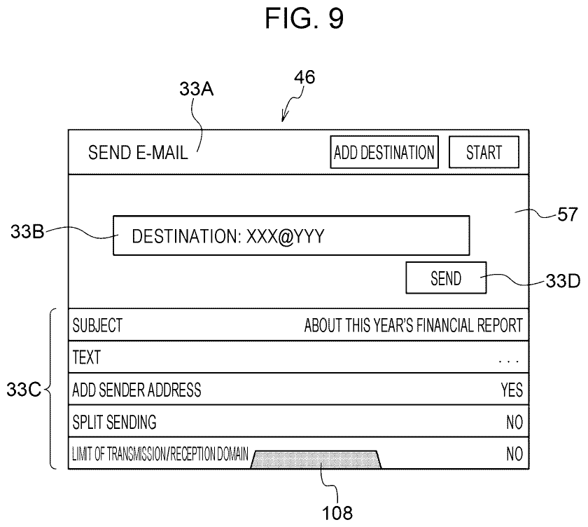

Further, as illustrated in FIG. 9, instead of the operation mark 106 (see FIG. 7), the operation panel 16 may display an instruction screen 46 on which an operation mark 108 such as a protruding pull-out piece is displayed at a lower portion of a currently displayed screen 57. In one example, on the instruction screen 46, the user may swipe the operation mark 108 in the upward direction so as to pull out the operation mark 108 so that an instruction to redisplay the deleted banner 104 (see FIG. 8) may be accepted. In this case, an operation method by swiping the operation mark 108 in a specified direction and an instruction to redisplay the banner are managed in association with each other.

### (Configurations and Issue of Typical Information Processing System, First Comparative Example, and Second Comparative Example)

Here, configurations and issue of a typical information processing system, a multifunction peripheral of a first comparative example, and a smartphone of a second comparative example will be described.

Typically, in an information processing system, after an instruction for a job such as e-mail sending is given, the instructed job may be performed in the background. At that time, in order to notify a user of a progress status of the instructed job, a banner describing the progress status of the job may be displayed in a superimposed manner on the currently displayed display screen. For example, the banner appears from the bottom to the top of the display screen until the banner occupies a predetermined area, and automatically moves backward and disappears after a specified time has elapsed. The specified time is several seconds (e.g., two seconds or more and four seconds or less), and a part of the lower portion of the display screen is occupied by the banner during the time period, and therefore, for example, in a case where e-mail sending is continuously performed, it is conceivable that the banner becomes an obstacle at the time of setting of e-mail sending.

As described above, since the banner describing the information to be notified to the user occupies a part of the display screen due to the superimposition, the user may want to delete a banner that is unnecessary at the notification timing or even a banner that is necessary after the notification is grasped. In this case, when the contents of the notified banner are necessary later or when the confirmation of the notification is insufficient, there is a need to confirm the notified contents again.

In the multifunction peripheral according to the first comparative example, when the user selects “notification application” arranged on the home screen displayed on the operation panel of the housing, the screen transitions to a notification target application, and notification content is displayed on the transitioned screen. Thus, on the screen transitioned to the notification target application, the user may confirm the notification content.

Furthermore, in the smartphone according to the second comparative example, in a case where the user deletes the banner on the display screen, the selection of a notification target application causes a transition to the notification target application, and notification content is displayed on the transitioned screen.

In both cases of the multifunction peripheral of the first comparative example and the smartphone of the second comparative example, the user confirms the notification content on the screen transitioned to the notification target application. Therefore, there is no way for displaying the notification content of the banner on the currently displayed screen, and it takes time and effort to transition to another application in order to confirm the notification content.

### (Configuration of Main Part of Information Processing System According to First Exemplary Embodiment)

In the information processing system 10 according to the first exemplary embodiment, as illustrated in FIG. 4, on the banner display screen 34, the delete button 103 is displayed on the banner 102 indicating that the progress status of the e-mail sending job is sending. When the user presses the delete button 103, the banner 102 displayed in a superimposed manner on a part of the display screen 52 may be deleted (i.e., erased from the display screen 52). Alternatively, instead of the delete button 103, the banner 102 may be deleted by performing a swiping operation on the banner 102 in a downward direction.

Furthermore, when the banner 104 is deleted, as illustrated in FIG. 7, on the instruction screen 42, the operation mark 106 for redisplaying the deleted banner 104 is displayed in a part of the currently displayed screen 55. For example, when the user presses the operation mark 106 (i.e., when the user gives an explicit display instruction), the banner 104 is redisplayed in a part of the currently displayed screen 56, as illustrated in FIG. 8.

In response to an explicit display instruction from the user, the information processing system 10 may redisplay not only the deleted banner but also the banner that automatically disappeared after a lapse of the specified time.

### (Effect of First Exemplary Embodiment)

Next, an effect of the information processing system 10 according to the first exemplary embodiment will be described.

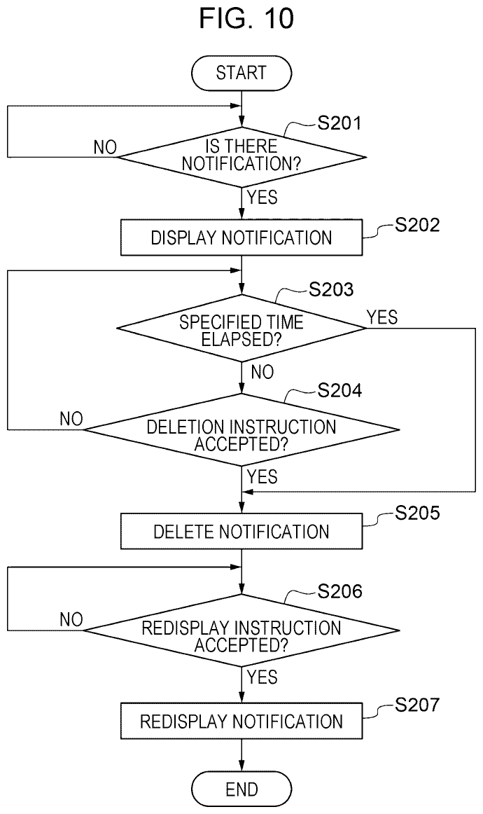

FIG. 10 is a flowchart illustrating a flow of information processing for which the information processing system 10 is responsible according to the first exemplary embodiment. In the information processing system 10, the CPU 11 reads an information processing program from the ROM 12 or the storage 14, loads and executes the information processing program in the RAM 13, and thus performs information processing.

The CPU 11 determines whether there is a notification to the user, that is, a notification as the information to be notified to the user (Step S201). For example, as illustrated in FIG. 3, when the progressing status of e-mail sending is notified in a case where an e-mail sending job is executed, the CPU 11 determines that there is a notification to the user.

When there is a notification to the user (Step S201: YES), the CPU 11 displays the notification on a part of the display screen of the operation panel 16 (Step S202). For example, as illustrated in FIG. 4, the banner 102 for notification is displayed in the lower portion of the display screen 52 so as to be superimposed on the display screen 52.

When there is no notification to the user (Step S201: NO), the CPU 11 waits until there is a notification to the user.

The CPU 11 determines whether a specified time has elapsed (Step S203). The specified time is set in advance to, for example, a time period of two seconds or more and five seconds or less.

When the specified time has not elapsed (Step S203: NO), the CPU 11 determines whether an instruction to delete the notification has been accepted (Step S204). The instruction to delete the notification means an explicit notification deletion instruction from the user. For example, as illustrated in FIG. 4, when the user presses the delete button 103 displayed on the banner 102, it is determined that an explicit banner deletion instruction from the user has been accepted.

When the instruction to delete the notification has been accepted (Step S204: YES), the CPU 11 deletes the notification on the display screen (Step S205). Although not illustrated, for example, when an instruction to delete the banner 102 illustrated in FIG. 4 is accepted, the CPU 11 deletes the banner 102 on the display screen 52. Further, for example, as illustrated in FIG. 7, when an instruction to delete the banner 104 (see FIG. 8) is accepted, the CPU 11 displays the operation mark 106 for redisplaying the deleted banner 104 on the currently displayed screen 55 after the banner 104 is deleted.

When the specified time has elapsed (Step S203: YES), the CPU 11 deletes the notification on the display screen in the same manner as described above (Step S205). Thus, the banner 102 for notification illustrated in FIG. 4 is displayed in a superimposed manner in the lower portion of the display screen 52 for the specified time.

The CPU 11 determines whether an instruction to redisplay the deleted notification has been accepted (Step S206). For example, as illustrated in FIG. 7, when the user presses the operation mark 106, it is determined that an instruction to redisplay the deleted banner 104 for notification has been accepted.

When an instruction to redisplay the deleted notification has been accepted (Step S206: YES), the CPU 11 redisplays the deleted notification (Step S207). For example, as illustrated in FIG. 8, the banner 104 for notification is redisplayed in the lower portion of the currently displayed screen 56. Although not illustrated, for example, after the banner 102 for notification is deleted, in a case where the operation mark for redisplaying the deleted banner 102 for notification is pressed on the currently displayed screen, the banner 102 for notification is redisplayed on the currently displayed screen.

When no instruction to redisplay the deleted notification has been accepted (Step S206: NO), the CPU 11 waits until the instruction to redisplay the deleted notification is accepted. Thus, the processing based on the information processing program for which the information processing system 10 is responsible ends.

As described above, in the information processing system 10, the CPU 11 accepts the instruction to delete the banner displayed in a superimposed manner on a part of the display screen of the operation panel 16 and, after deleting the banner, redisplays the banner on the screen currently displayed on the operation panel 16 by the operation of the specific user (see FIGS. 7 and 8). According to the first exemplary embodiment, the specific user is the user who deleted the banner. Therefore, in the information processing system 10, after the banner displayed in a superimposed manner on a part of the display screen is deleted by the deletion operation of the user, the user may check the content of the banner on the screen currently displayed on the operation panel 16 (for example, the currently displayed screen 56 illustrated in FIG. 8). Therefore, in the information processing system 10, it is possible to reduce the time and effort of the user for confirming the notification content, as compared with a case where the notification content is displayed on the screen transitioned to the notification target application after the banner is deleted.

Furthermore, in the information processing system 10, the operation of the specific user to redisplay the banner is an operation performed by one action on the currently displayed screen (e.g., pressing of the operation mark 106 illustrated in FIG. 7). Therefore, in the information processing system 10, the time and effort for redisplaying the banner is reduced, as compared with a case where the operation of the user to redisplay the banner is an operation performed by a plurality of actions on the currently displayed screen.

In the information processing system 10, the instruction to delete the banner is a deletion operation by the user to delete the banner on the display screen of the operation panel 16 (see FIG. 4). Furthermore, the operation of the specific user for redisplaying the banner is an operation of the user who deleted the banner. The CPU 11 redisplays the banner deleted by the deletion operation by a redisplay operation of the user who performed the deletion operation. Therefore, in the information processing system 10, after the user deletes the banner, the banner may be displayed at timing when the user wants to check the banner.

Furthermore, in the information processing system 10, the CPU 11 displays, on the screen currently displayed on the operation panel 16, the operation mark 106 for redisplaying the deleted banner without accepting the user's instruction to display the operation mark (see FIG. 7). Then, the user's operation for redisplay is performed by the user operating the operation mark 106. For this reason, in the information processing system 10, it is possible to reduce the time and effort of the user when redisplaying the banner, as compared with a case where the redisplay button is displayed by a new operation of the user on the currently displayed screen.

Further, the information processing program causes the information processing system 10 to execute a process of accepting the instruction to delete the banner displayed in a superimposed manner on a part of the display screen of the operation panel 16 and, after deleting the banner, redisplaying the banner on the screen currently displayed on the operation panel 16 by the user's operation. Therefore, in the information processing program, the user may confirm the content of the banner on the screen currently displayed on the operation panel 16 after the banner displayed in a superimposed manner on a part of the display screen is deleted by the deletion operation of the user.

### [First Modification]

Next, an information processing system according to a first modification will be described. The same components as those in the above-described first exemplary embodiment are denoted by the same reference numerals, and the description thereof will be omitted.

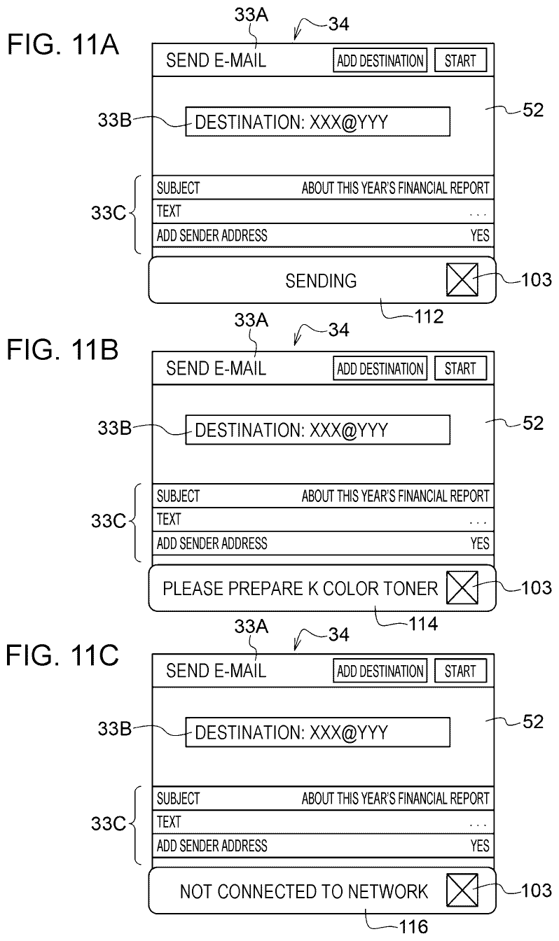

In the information processing system 10 according to the first modification, as illustrated in FIGS. 11A, 11B, and 11C, the storage 14 stores the position of the operation mark for each type of banners 112, 114, and 116 as examples of the information item. The storage 14 is an example of a memory.

As illustrated in FIGS. 11A, 11B, and 11C, in the lower portion of the display screen 52, the different types of banners 112, 114, and 116 are displayed in a superimposed manner on the display screen 52. The type of banners includes, for example, three types: a status display banner, a notification banner, and an error banner. The status display banner is an example of a status display item for displaying a processing status, and the notification banner is an example of a notification item for notifying a user of specified information. The error banner is an example of an execution impossibility notification that is displayed when processing is inexecutable.

As illustrated in FIG. 11A, the banner 112 is a status display banner indicating a processing status (e.g., sending). As illustrated in FIG. 11B, the banner 114 is a notification banner for notifying the user of the content that is not directly related to the currently displayed application. The notification banner may be, for example, “it will rain today”. Further, as illustrated in FIG. 11C, the banner 116 is an error banner for notifying a failure (e.g., the processing is inexecutable) related to the currently displayed application. The error banner may be, for example, “e-mail cannot be sent”.

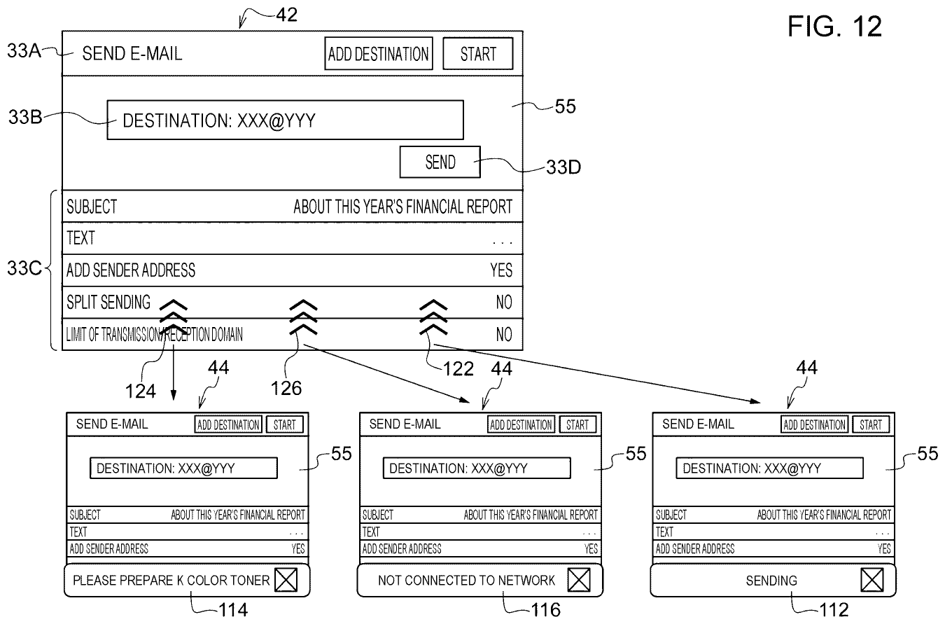

As illustrated in FIG. 12, when the banners 112, 114, and 116 are deleted, the storage 14 stores the positions of operation marks 122, 124, and 126 on the currently displayed screen 55 for the respective types of the banners 112, 114, and 116. In one example, the position of the operation mark 122 for redisplaying the banner 112 is on the right side of the lower portion of the currently displayed screen 55, the position of the operation mark 124 for redisplaying the banner 114 is on the left side of the lower portion of the currently displayed screen 55, and the position of the operation mark 126 for redisplaying the banner 116 is in the middle of the lower portion of the currently displayed screen 55.

The CPU 11 redisplays the specified types of banners 112, 114, and 116 in response to the operation of the operation marks 122, 124, and 126 at the corresponding positions. For example, when the operation mark 122 is operated (e.g., clicked or swiped), the banner 112 is redisplayed, and when the operation mark 124 is operated (e.g., clicked or swiped), the banner 114 is redisplayed. When the operation mark 126 is operated (e.g., clicked or swiped), the banner 116 is redisplayed. Other configurations of the information processing system 10 according to the first modification are the same as the configurations of the information processing system 10 according to the first exemplary embodiment.

In the information processing system 10 according to the first modification, the following effects may be obtained in addition to the effects of the configuration similar to that of the information processing system 10 according to the first exemplary embodiment.

In the information processing system 10 according to the first modification, the types of banners include the status display banner, the notification banner, and the error banner. The banner 112 is a status display banner, the banner 114 is a notification banner, and the banner 116 is an error banner. Therefore, in the information processing system 10, the banner 112, 114, or 116 of a desired type may be promptly redisplayed, as compared with a case where the same operation is performed to redisplay the banner regardless of the type of the banner. Here, “promptly” means that it is difficult for a user to perform an unintended operation.

Further, in the information processing system 10, the storage 14 stores the positions of the operation marks 122, 124, and 126 for the respective types of the banners 112, 114, and 116. The CPU 11 redisplays the specified types of the banners 112, 114, and 116 in response to an operation of the operation marks 122, 124, and 126 at the corresponding positions. Therefore, in the information processing system 10, the banner 112, 114, or 116 of a desired type may be promptly redisplayed, as compared with a case where the position of the operation mark for redisplay is the same regardless of the type of banner.

In the information processing system 10, the type of banner may be associated with not only the position of the operation mark but also an operation of the operation mark. In this case, for example, the storage 14 stores a user operation to redisplay a banner for each type (e.g., an operation of pressing or swiping an operation mark). The CPU 11 redisplays the specified type of banner in response to a corresponding operation (e.g., an operation of pressing or swiping the operation mark). In the information processing system 10, an intended banner is easily redisplayed, as compared with a case where the same operation is performed to redisplay the banner regardless of the type of banner.

### [Second Modification]

Next, an information processing system according to a second modification will be described. The same components as those in the first exemplary embodiment and the first modification are denoted by the same reference numerals, and the description thereof will be omitted.

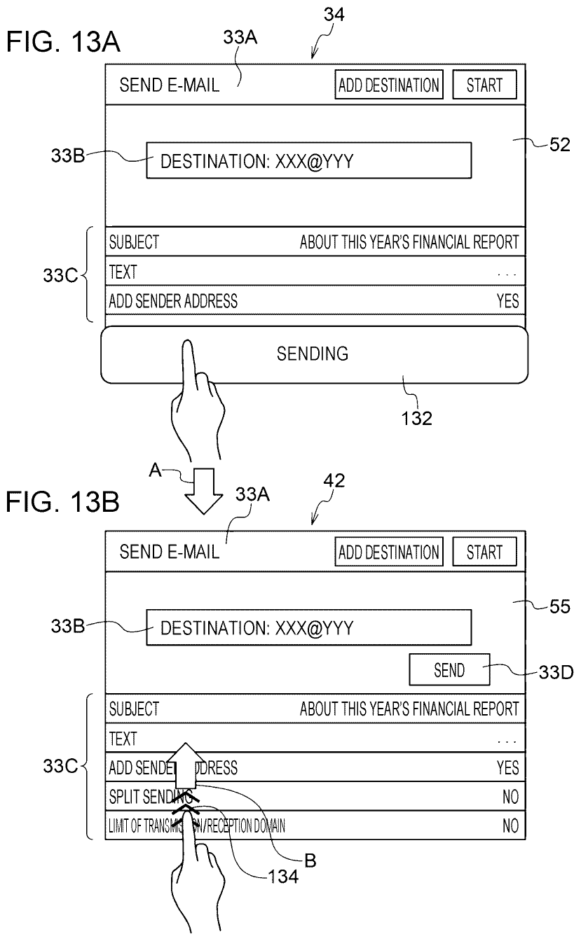

In the information processing system 10 according to the second modification, as illustrated in FIGS. 13A and 13B, a redisplay operation corresponding to an operation of deleting a banner is associated. For example, the operation of deleting the banner and the redisplay operation corresponding to the operation of deleting the banner are stored in the storage 14 in association with each other.

As illustrated in FIG. 13A, the operation of deleting a banner 132 is an action of sliding the banner 132 with a finger in a specified direction (e.g., a downward direction indicated by the arrow A) on the display screen 52. As illustrated in FIG. 13B, the redisplay operation is an action of sliding, with the finger, an operation mark 134 for redisplay, which is displayed on the currently displayed screen 55, in a direction (e.g., the upward direction indicated by the arrow B) opposite to the specified direction described above.

In one example, when the operation mark 134 is operated in a direction (e.g., the upward direction indicated by the arrow B) opposite to the specified direction described above at the position equivalent to the deletion operation in the specified direction (e.g., the downward direction indicated by the arrow A) of the banner 132 on the display screen 52, the banner 132 may be redisplayed. For example, in a case where the banner 132 is deleted by a downward swipe operation on the left side of the display screen 52, when it is desired to redisplay the deleted banner 132, an upward swipe operation on the left side of the currently displayed screen 55 is performed. At this time, the deleted banner 132 is not redisplayed in response to a downward swipe operation on the right side of the currently displayed screen 55 or an upward swipe operation on the right side of the currently displayed screen 55. Other configurations of the information processing system 10 according to the second modification are the same as those of the information processing system 10 according to the first exemplary embodiment and the first modification.

In the information processing system 10 according to the second modification, the following effects may be obtained in addition to the effects of the configurations similar to those of the information processing system 10 according to the first exemplary embodiment and the first modification.

In the information processing system 10 according to the second modification, the operation of deleting the banner 132 is an action of sliding the banner 132 with a finger in the specified direction (e.g., the downward direction indicated by the arrow A), and the redisplay operation is an action of sliding the operation mark 134 with a finger in the direction (e.g., the upward direction indicated by the arrow B) opposite to the specified direction described above. Therefore, in the information processing system 10, when the banner is deleted by the action of sliding the banner in the specified direction on the display screen with the finger, the deleted banner may be redisplayed promptly as compared with a case where the banner is redisplayed by a redisplay operation unrelated to the specified direction.

According to the second modification, as the corresponding redisplay operation, the position is equivalent to the position of the deletion operation and the direction of the swipe operation is opposite, but the present disclosure is not limited thereto. For example, the banner may be redisplayed by a swipe operation in the same direction as that of the deletion operation. However, the operation in the opposite direction at the position equivalent to the position of the deletion operation provides an advantage that it is easy for the user to understand intuitively because it is close to a normal sense of pulling out what is pushed in. Further, a translucent triangular operation mark may be displayed to indicate the operation position and direction of the operation mark. In addition, a protruding operation mark may be displayed, and the operation mark may be swiped in a protruding direction.

### Second Exemplary Embodiment

Next, an information processing system according to a second exemplary embodiment will be described. The same components as those in the first exemplary embodiment, the first modification, and the second modification described above are denoted by the same reference numerals, and the description thereof will be omitted.

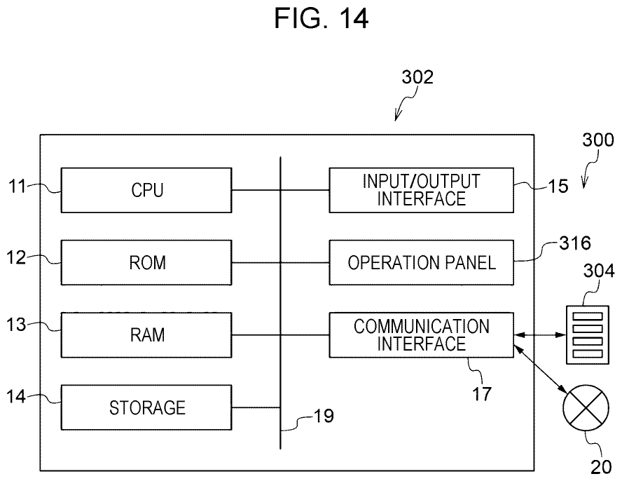

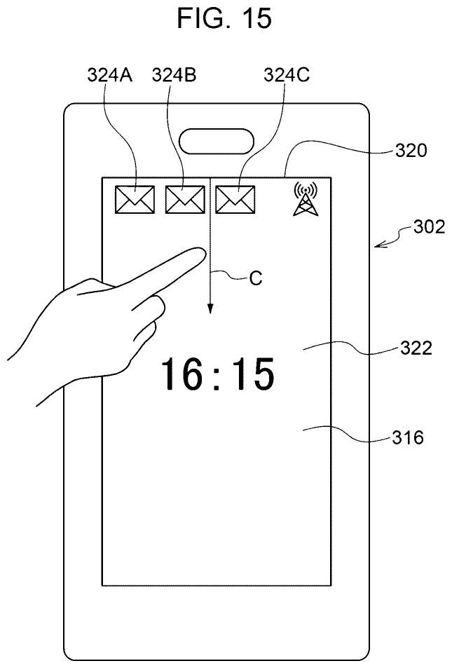

As illustrated in FIG. 14, an information processing system 300 according to the second exemplary embodiment includes a user terminal 302. The user terminal 302 is, for example, a smartphone (see FIG. 15). A smartphone is a mobile phone having functions similar to those of a personal computer.

The user terminal 302 includes each component such as the CPU 11, the ROM 12, the RAM 13, the storage 14, the input/output interface 15, an operation panel 316, and the communication interface 17. The components are communicably connected to each other via the bus 19. The user terminal 302 may communicate with a notification center 304 via the communication interface 17. The user terminal 302 may be connected to the network 20 via the communication interface 17.

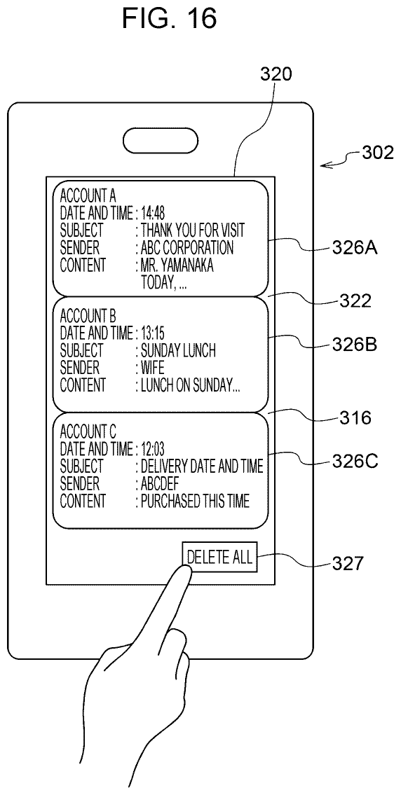

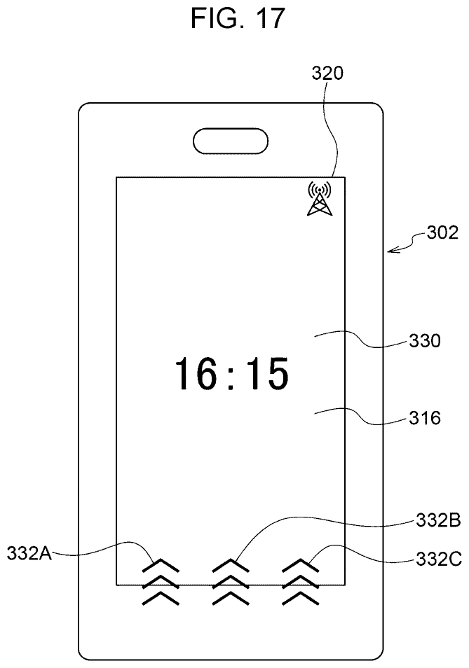

In the information processing system 300, the notification information for notifying the user is received by the user terminal 302 from the notification center 304. The notification information includes a plurality of (for example, three) banners 326A, 326B, and 326C (see FIG. 16) as an example of information items. In the user terminal 302, the storage 14 stores the positions of operation marks 332A, 332B, and 332C (see FIG. 17) in accordance with the notification times of banners 326A, 326B, and 326C.

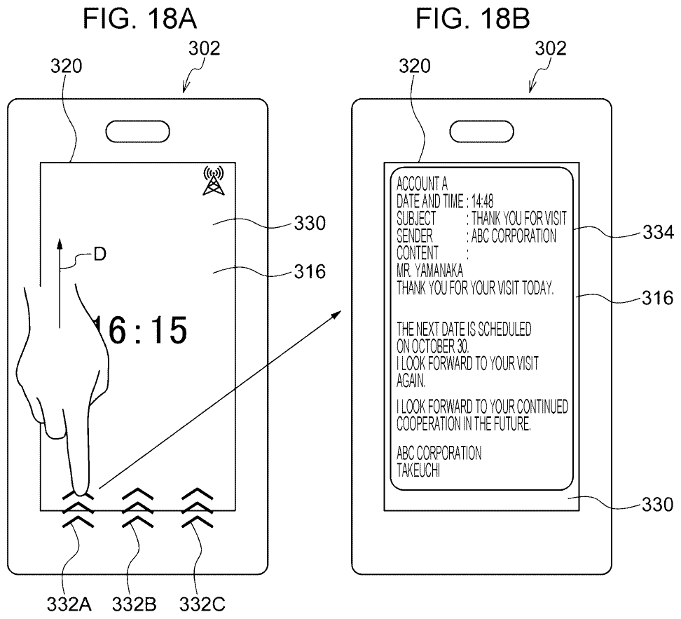

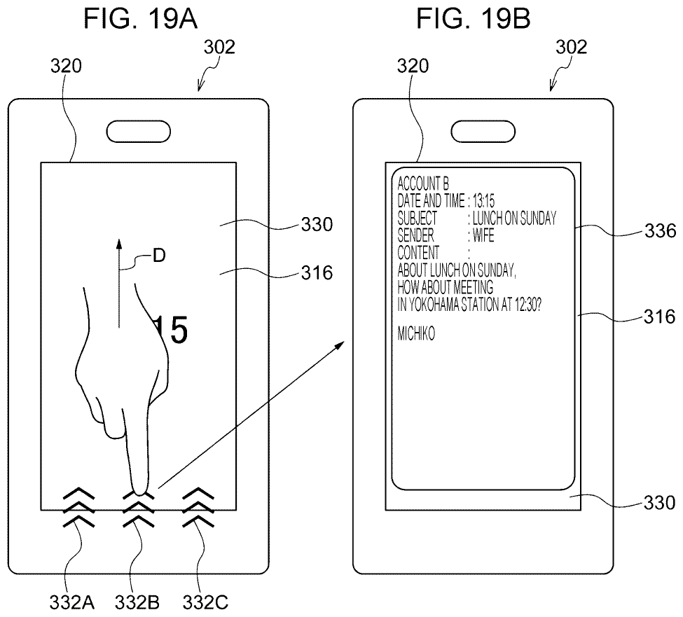

The CPU 11 redisplays, in response to the operations of the operation marks 332A, 332B, and 332C at the corresponding positions, the banners 326A, 326B, and 326C corresponding to the specified notification time or the notification content associated with the banners 326A, 326B, and 326C on the operation panel 316 (see FIGS. 18 and 19).

Next, an example of a display screen of the operation panel 316 in the user terminal 302 will be specifically described.

As illustrated in FIG. 15, the user terminal 302 includes a bezel 320 as a frame body along the circumferential direction of the operation panel 316. In an upper portion of a display screen 322 of the operation panel 316, icons 324A, 324B, and 324C indicating received e-mails notified from the notification center 304 are displayed. The icon refers to a small picture or symbol displayed on the screen of a computer or smartphone. The icon is designed to visually represent an application or a function so that a user may intuitively operate it. As an example, the icons 324A, 324B, and 324C are displayed from the left side to the right side of the upper portion of the display screen 322 in reverse chronological order of the e-mail receiving time (that is, notification time). Alternatively, the icons 324A, 324B, and 324C may be displayed from the left side to the right side of the upper portion of the display screen 322 in chronological order of the e-mail receiving time.

As illustrated in FIG. 16, the banners 326A, 326B, and 326C indicating the information of the icons 324A, 324B, and 324C are displayed in a superimposed manner on a part of the display screen 322 by a downward swipe operation indicated by the arrow C across the upper bezel 320 in the user terminal 302. Each of the banners 326A, 326B, and 326C is an example of an information item and is information indicating a part of notification content (in this example, e-mail content). As an example, the banners 326A, 326B, and 326C correspond to the icons 324A, 324B, and 324C, respectively, and are displayed from the upper side to the lower side in reverse chronological order of the e-mail receiving time. Alternatively, the banners 326A, 326B, and 326C may be displayed from the upper side to the lower side in chronological order of the e-mail receiving time.

A delete button 327 is displayed at a lower portion of the operation panel 316. By pressing the delete button 327, all the banners 326A, 326B, and 326C are deleted on a display screen 330, as illustrated in FIG. 17. At this time, by deleting the banners 326A, 326B, and 326C, the icons 324A, 324B, and 324C (see FIG. 15) indicating received e-mails in the upper left portion are deleted on the display screen 330. Operation marks 332A, 332B, and 332C for redisplaying the deleted banners 326A, 326B, and 326C appear in a lower portion of the display screen 330. The display screen 330 is an example of a currently displayed screen. The operation marks 332A, 332B, and 332C correspond to the banners 326A, 326B, and 326C, respectively, and are displayed on the lower portion of the display screen 330 from the left side to the right side in reverse chronological order of e-mail reception.

According to the second exemplary embodiment, the operation marks 332A, 332B, and 332C for redisplay are associated with a registration account of an e-mail application. Here, the account refers to the right required for using a smartphone, a personal computer, or a service on the Internet, and personal authentication information.

As illustrated in FIGS. 18A and 18B, when the operation mark 332A on the left side is swiped upward as indicated by the arrow D, the deleted banner 326A of the account associated with the operation mark 332A or a notification content (for example, e-mail content) 334 related to the banner 326A is displayed. FIG. 18B illustrates an example in which the notification content (e.g., e-mail content) 334 related to the banner 326A is displayed.

As illustrated in FIGS. 19A and 19B, when the operation mark 332B in the middle is swiped upward as indicated by the arrow D, the deleted banner 326B of the account associated with the operation mark 332B or a notification content (for example, e-mail content) 336 related to the banner 326B is displayed. FIG. 19B illustrates an example in which the notification content (e.g., e-mail content) 336 related to the banner 326B is displayed. Thus, the banners 326A, 326B, and 326C corresponding to the accounts are selectively displayed.

In a case where the banner 326A or the banner 326B is redisplayed, the notification content 334 may be displayed by a touch operation on the banner 326A, or the notification content 336 may be displayed by a touch operation on the banner 326B. The other configuration of the information processing system 300 according to the second exemplary embodiment is similar to that of the information processing system 10 according to the first exemplary embodiment, the first modification, and the second modification.

In the information processing system 300 according to the second exemplary embodiment, the following effects may be obtained in addition to the effects of the configurations similar to those of the information processing systems 10 according to the first exemplary embodiment, the first modification, and the second modification.

In the user terminal 302, the positions of the operation marks 332A, 332B, and 332C (see FIG. 17) are stored in the storage 14 in accordance with the notification times (that is, e-mail receiving times) of the banners 326A, 326B, and 326C. The CPU 11 redisplays the banners 326A, 326B, and 326C corresponding to the specified notification times in response to the operations of the operation marks 332A, 332B, and 332C at the corresponding positions. Therefore, in the information processing system 300, it is possible to promptly redisplay the banners 326A, 326B, and 326C at the desired notification time, as compared with a case where the position of the banner to be redisplayed is the same regardless of the notification time of the information item.

### [Third Modification]

Next, an information processing system according to a third modification will be described. The same components as those in the first exemplary embodiment, the first modification, the second modification, and the second exemplary embodiment are denoted by the same reference numerals, and the description thereof will be omitted.

The third modification is a modification of the information processing system 300 according to the second exemplary embodiment. In the user terminal 302, when there is the plurality of (e.g., three) deleted banners 326A, 326B, and 326C, the CPU 11 displays only the banner 326A with the latest notification time. When there is the plurality of deleted banners 326A, 326B, and 326C, the CPU 11 may redisplay the banners 326A, 326B, and 326C in reverse chronological order of the notification time.

Next, an example of a display screen of the operation panel 316 in the user terminal 302 will be specifically described.

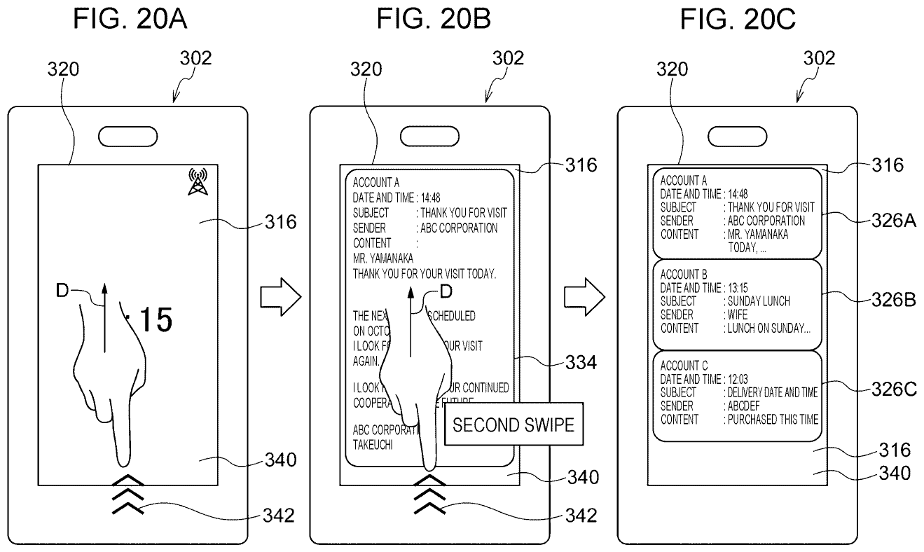

When the plurality of (e.g., three) banners 326A, 326B, and 326C is deleted, as illustrated in FIG. 20A, a single (that is, one) operation mark 342 is displayed in the middle of the lower portion of the display screen 340. The display screen 340 is an example of the currently displayed screen. When the operation mark 342 is swiped upward as indicated by the arrow D, as illustrated in FIG. 20B, only the notification content 334 related to the banner 326A with the latest notification time is displayed. Furthermore, the single operation mark 342 is displayed in the middle of the lower portion of the display screen 340. Alternatively, only the banner 326A with the latest notification time may be displayed, and when the banner 326A is touched, the notification content 334 related to the banner 326A may be displayed.

On the display screen 340 illustrated in FIG. 20B, when the operation mark 342 is swiped upward as indicated by the arrow D (i.e., a second swipe operation is performed), the banners 326A, 326B, and 326C are redisplayed as illustrated in FIG. 20C. As an example, the banners 326A, 326B, and 326C are displayed from the upper side to the lower side of the operation panel 316 in reverse chronological order of the notification time. Instead of this configuration, a configuration may be adopted in which the banners 326A, 326B, and 326C are displayed one by one in reverse chronological order of the notification time by scrolling the operation panel 316 in the horizontal direction (in the right-left direction).

In the above-described case, since it is necessary to increase the number of times of selection in order to display the banners 326A, 326B, and 326C associated with different accounts, for example, in a case where the redisplayed banners 326A, 326B, and 326C are selected again, the latest notification content (e.g., e-mail content) of each account may be displayed. Other configurations of the information processing system 300 according to the third modification are the same as those of the information processing systems 10 according to the first exemplary embodiment, the first modification, and the second modification, and the information processing system 300 according to the second exemplary embodiment.

In the information processing system 300 according to the third modification, the following effects may be obtained in addition to the effects of the configurations similar to those of the information processing systems 10 according to the first exemplary embodiment, the first modification, and the second modification and the information processing system 300 according to the second exemplary embodiment.

In the user terminal 302, when there is the plurality of (e.g., three) deleted banners 326A, 326B, and 326C, the CPU 11 performs a first swipe operation of the operation mark 342 so that only the banner 326A with the latest notification time or the notification content 334 related to the banner 326A is displayed. In addition, in a case where there is the plurality of deleted banners 326A, 326B, and 326C, the CPU 11 performs a second swipe operation of the operation mark 342 so that the banners 326A, 326B, and 326C are redisplayed in reverse chronological order of the notification time. Therefore, in the information processing system 300, when there is a plurality of deleted banners, the desired banners 326A, 326B, and 326C may be promptly redisplayed as compared with the case where all the information items are redisplayed in the order of deletion.

### [Others]

The information processing system according to the present disclosure is not limited to the information processing systems described according to the first exemplary embodiment, the first modification, the second modification, the second exemplary embodiment, and the third modification, and various modifications are possible.

According to the first exemplary embodiment, the first modification, the second modification, the second exemplary embodiment, and the third modification, the operation of the specific user to redisplay the banner is by the user who deleted the banner, but the present disclosure is not limited thereto, and may be changed. For example, by performing user authentication, the deleted banner may be redisplayed by a redisplay operation of a specified user other than the user who deleted the banner.

Furthermore, in the information processing system, the banner to be redisplayed in response to a user operation may be changed as follows.

For example, when an operation of pulling out the deleted banner (that is, an operation of redisplaying the banner) is performed, if there is a plurality of banners, only the recent banner may be redisplayed. Further, for example, in a case where an operation of pulling out a deleted banner (that is, an operation of redisplaying a banner) is performed, if there is a plurality of banners, the banners may be sequentially redisplayed in chronological order (for example, in order of notification time).

For example, in a case where an operation of pulling out a banner (that is, an operation of redisplaying a banner) is performed after an operation of continuously deleting banners is performed, a banner other than the first banner may be redisplayed. This is to prevent the first banner from being redisplayed because the first banner is highly likely to have been deleted after confirmation. Since there is a possibility that the banner other than the first banner is deleted by mistake in the flow of the operation, the banner is redisplayed.

In the information processing system, the banner to be redisplayed may be changed as follows.

For example, it is assumed that the banner to be redisplayed is a banner deleted in the session. For example, in the case of a multifunction peripheral, a period from login to logout is one session, and a banner deleted at the time of previous login is prevented from being redisplayed.

Even in the above-described case, in a case where there is a job instructed to be executed and completed after logout (e.g., a job which is executed in the background such as FAX transmission and is completed after logout), the banner may be redisplayed in a case where the redisplay operation is exceptionally performed for the first time at the time of the next login. In this case, the information of the previous session may be extracted.

For example, the banner to be redisplayed may be selectively selected from all the past banners deleted by the user. Thus, the banner deleted at the time of the previous login may be redisplayed.

In the case of a shared device of a multifunction peripheral, a banner to be notified is managed for each user, and a banner corresponding to a logged-in user may be redisplayed.

Regarding the notification of the common banner, depending on the content, even if the banner is redisplayed by another user, the banner may be redisplayed when another user performs a redisplay operation.

The processes of the information processing system 10, the information processing system 300, and the user terminal 302 described above may also be realized by a dedicated hardware circuit. In this case, the processing may be executed by one piece of hardware or may be executed by a plurality of pieces of hardware.

A program for operating the information processing system 10, the information processing system 300, and the user terminal 302 may be provided by a computer-readable recording medium, such as a Universal Serial Bus (USB) memory, a flexible disk, or a Compact Disc Read Only Memory (CD-ROM), or may be provided online via a network, such as the Internet.

In this case, the program recorded on the computer-readable recording medium is normally transferred to and stored in a memory, a storage, or the like. In addition, for example, the program may be provided as independent application software, or may be incorporated into software of each device as one function of the information processing system 10, the information processing system 300, and the user terminal 302.

Although a specific exemplary embodiment of the present disclosure has been described in detail, the present disclosure is not limited to such an exemplary embodiment, and it is apparent to those skilled in the art that various other exemplary embodiments are possible within the scope of the present disclosure.

### APPENDIX

(((1)))

An information processing system comprising at least one processor configured to, after accepting an instruction to delete an information item displayed in a superimposed manner on a part of a display screen of a display unit and deleting the information item, redisplay the information item by an operation of a specific user on a screen currently displayed on the display unit.

(((2)))

The information processing system according to (((1))), wherein
a memory stores the operation for redisplay for each type of the information item, and
the processor is configured to redisplay the information item of a specified type in response to the corresponding operation.
   (((3)))

The information processing system according to (((1))) or (((2))), wherein the operation of the specific user to redisplay the information item is an operation by one action on the screen currently displayed.

(((4)))

The information processing system according to any one of (((1))) to (((3))), wherein
the instruction to delete the information item is a user's deletion operation to delete the information item on the display screen of the display unit, and
the operation of the specific user to redisplay the information item is an operation of a user who deleted the information item.
   (((5)))

The information processing system according to (((4))), wherein the processor is configured to redisplay the information item deleted by the deletion operation by a redisplay operation of a user corresponding to the deletion operation.

(((6)))

The information processing system according to (((2))), wherein the type of the information item includes at least two or more of a status display item for displaying a processing status, a notification item for notifying a user of specified information, and an execution impossibility notification item that is displayed when processing is inexecutable.

(((7)))

The information processing system according to any one of (((1))) to (((6))), wherein
the processor is configured to display, on the screen currently displayed, an operation mark for redisplaying the deleted information item without accepting a display instruction from a user, and
the operation is performed by a user operating the operation mark.
   (((8)))

The information processing system according to (((7))), wherein
a memory stores a position of the operation mark for each type of the information item, and
the processor is configured to redisplay the information item of a specified type in response to an operation of the operation mark at the corresponding position.
   (((9)))

The information processing system according to (((5))), wherein
the deletion operation is an action of sliding the information item with a finger in a specified direction on the display screen, and
the redisplay operation is an action of sliding, with a finger, an operation mark for redisplay, which is displayed on the screen currently displayed, in a direction opposite to the specified direction.
   (((10)))

The information processing system according to (((7))), wherein
a memory stores a position of the operation mark in accordance with a notification time of the information item, and
the processor is configured to redisplay the information item corresponding to a specified notification time in response to an operation of the operation mark at a corresponding position.
   (((11)))

The information processing system according to any one of (((1))) to (((10))), wherein when there is a plurality of the information items deleted, the processor is configured to redisplay the information item with the latest notification time or the information items in reverse chronological order of the notification time.

(((12)))

A program causing a computer to execute a process for information processing, the process comprising, after accepting an instruction to delete an information item displayed in a superimposed manner on a part of a display screen of a display unit and deleting the information item, redisplaying the information item by an operation of a specific user on a screen currently displayed on the display unit.

(((13)))

An information processing method comprising:
accepting an instruction to delete an information item displayed in a superimposed manner on a part of a display screen of a display unit;
deleting the information item; and
causing a computer to execute a process of redisplaying the information item by an operation of a specific user on a screen currently displayed on the display unit.

What is claimed is:

1. An information processing system comprising:
at least one processor configured to, after accepting an instruction to delete an information item displayed in a superimposed manner on a part of a display screen of a display unit and deleting the information item, redisplay the information item by an operation of a specific user on a screen currently displayed on the display unit.

2. The information processing system according to claim 1, wherein
a memory stores the operation for redisplay for each type of the information item, and
the processor is configured to redisplay the information item of a specified type in response to the corresponding operation.

3. The information processing system according to claim 1, wherein the operation of the specific user to redisplay the information item is an operation by one action on the screen currently displayed.

4. The information processing system according to claim 1, wherein
the instruction to delete the information item is a user's deletion operation to delete the information item on the display screen of the display unit, and
the operation of the specific user to redisplay the information item is an operation of a user who deleted the information item.

5. The information processing system according to claim 4, wherein the processor is configured to redisplay the information item deleted by the deletion operation by a redisplay operation of a user corresponding to the deletion operation.

6. The information processing system according to claim 2, wherein the type of the information item includes at least two or more of a status display item for displaying a processing status, a notification item for notifying a user of specified information, and an execution impossibility notification item that is displayed when processing is inexecutable.

7. The information processing system according to claim 1, wherein
the processor is configured to display, on the screen currently displayed, an operation mark for redisplaying the deleted information item without accepting a display instruction from a user, and
the operation is performed by a user operating the operation mark.

8. The information processing system according to claim 7, wherein
a memory stores a position of the operation mark for each type of the information item, and
the processor is configured to redisplay the information item of a specified type in response to an operation of the operation mark at the corresponding position.

9. The information processing system according to claim 5, wherein
the deletion operation is an action of sliding the information item with a finger in a specified direction on the display screen, and
the redisplay operation is an action of sliding, with a finger, an operation mark for redisplay, which is displayed on the screen currently displayed, in a direction opposite to the specified direction.

10. The information processing system according to claim 7, wherein
a memory stores a position of the operation mark in accordance with a notification time of the information item, and
the processor is configured to redisplay the information item corresponding to a specified notification time in response to an operation of the operation mark at a corresponding position.

11. The information processing system according to claim 1, wherein when there is a plurality of the information items deleted, the processor is configured to redisplay the information item with the latest notification time or the information items in reverse chronological order of the notification time.

12. A non-transitory computer readable medium storing a program causing a computer to execute a process for information processing,
the process comprising, after accepting an instruction to delete an information item displayed in a superimposed manner on a part of a display screen of a display unit and deleting the information item,
redisplaying the information item by an operation of a specific user on a screen currently displayed on the display unit.

13. An information processing method comprising:
accepting an instruction to delete an information item displayed in a superimposed manner on a part of a display screen of a display unit;
deleting the information item; and
causing a computer to execute a process of redisplaying the information item by an operation of a specific user on a screen currently displayed on the display unit.
